(19) United States
(12) Patent Application Publication
(10) Pub. No.: US 2007/0100773 A1
(43) Pub. Date: May 3, 2007

(54) Transaction security system having user defined security parameters

(75) Inventor: Benjamin T. Wallach, Montgomery, AL (US)

Correspondence Address: STEPTOE & JOHNSON LLP, 1330 CONNECTICUT AVENUE, N.W., WASHINGTON, DC, 20036, US

(73) Assignee: Regions Asset Company, Wilmington, DE (US)

(21) Appl. No.: 11/464,143

(22) Filed: Aug. 11, 2006

(51) Int. Cl. G06Q 99/00; H04L 9/00; H04K 1/00

(52) U.S. Cl. 705/75; 705/64

(57) ABSTRACT

A fraud-prevention system having user security parameters based on user instruction. A user specifies the security parameter for a transaction. The security parameter may include, but is not limited to a geographic location, a monetary value range, a transaction mode, an account access parameter, a class of goods, or a class of services. The fraud-prevention system acquires this security parameter information from the user and stores it in a user security parameter database. The fraud-prevention system uses these user security parameters to screen subsequent transactions.

### TECHNICAL FIELD

The invention relates to the field of network based security systems.

### BACKGROUND

Consumers and companies are vulnerable to fraudulent electronic transactions. However, transactional fraud is on the decline today largely because companies are now scrutinizing electronic transactions seconds before approving them. The fraud-prevention systems utilized by finance companies check transactions for indicia of fraud.

The primary computer based fraud-prevention system deployed today is neural networks. A neural network is a system of programs and data structures that approximates the operation of the human brain. A neural network usually can involve a large number of processors operating in parallel, each with its own small sphere of knowledge and access to data in its local memory. Typically, a neural network can be initially “trained” or fed large amounts of data and rules about data relationships. A program can then tell the network how to behave in response to an external stimulus (for example, to input from a computer user who is interacting with the network) or can initiate activity on its own (within the limits of its access to the external world).

In the area of electronic transactions, neural networks can learn patterns of legitimate behavior for consumers and business. Using this pattern of legitimate behavior, the neural network can then search and identify transactions that fall outside of this established behavioral pattern. The fraud-prevention system can use this information from the neural network to identify and block fraudulent transactions before they occur.

Neural networks can be a powerful tool for preventing electronic transactional fraud. However, the neural network is ineffective at preventing fraud during the period during which it is learning the legitimate pattern of behavior. Further, while the neural network can learn a legitimate pattern of behavior for a consumer or business, that pattern may not fully reflect the customer's or business' actual pattern of behavior. Still further, the neural network may prove slow in adapting to the changing behavioral patterns of consumers and businesses. It is therefore desirable to develop improved methods and systems for electronic transaction fraud-prevention. Electronic transactions encompass all possible electronic transactions, such as, but not limited to, financial electronic transactions and electronic account transactions.

### SUMMARY

A fraud-prevention system having user security parameters based on user instruction can include a network based security system that regulates transactions based upon a predetermined set of parameters specified by a user. A user specifies the security parameter for a transaction. A user is a customer, purchaser, cardholder, account manager, or agent having responsibility for the transaction. A user's identity can be verified by personalized parameters. The security parameter may include, but is not limited to a geographic location, a monetary value range, a transaction mode, an account access parameter, a class of goods, or a class of services. The user may vary these security parameters at any time. The user may specify certain security parameters for a predetermined amount of time only. For instance, the user may allow transactions from a particular geographic location for a period of time during which the user is on vacation at that location. The transaction may include, but is not limited to financial transactions and account access transactions.

The fraud-prevention system can acquire this security parameter information from the user and can store it in a user security parameter database. The user may specify these user security parameters at the outset of acquiring a financial account for conducting transactions, or at any time thereafter. The fraud-prevention system can use these user security parameters to screen subsequent transactions. When transactions contain indicia outside of the user security parameters, the fraud-prevention system may either warn the user with a warning message and allow the transaction, or the fraud-prevention system may block the transaction with or without sending a warning message. The fraud-prevention system can block the transaction by signaling a neural network or a third party notification system, or, in certain embodiments, within the system itself. The fraud-prevention system allows transactions that comport with the user security parameters.

The fraud-prevention system screens fraudulent transactions by first establishing a user security parameter based on a user instruction. Then the system receives a transaction characterized by a transaction parameter. The system compares the transaction parameter to the user security parameter to evaluate the transaction. The system may further determine whether to process the transaction and provide notice to the user. A user may temporarily adjust the user security parameter for a predetermined period of time, such as for the duration of a business trip. It is desirable that the user security parameter be established prior to conducting any transactions. The fraud-prevention system manages financial transactions and account access transactions. The user security parameter can cover transaction characteristics such as, by means of a non-limiting example, geographic locations, monetary value ranges, transaction modes, account access parameters, classes of goods, and classes of services. The user may select a security parameter in which to allow transactions. The user may select a security parameter in which to block transactions. The user may further select a security parameter in which to send a notice to the user. In addition to utilizing the user security parameters, the fraud-prevention system may further analyze the transaction parameter with a neural network.

The fraud-prevention system also distinguishes fraudulent transactions from non-fraudulent transactions by providing an interface capable of setting a user security parameter by a user instruction, comparing a transaction parameter that characterizes a transaction to the user security parameter, and determining whether the transaction is fraudulent or non-fraudulent.

The fraud-prevention system further screens transactions by setting a user security parameter manually by a user instruction before processing any transactions, comparing the user security parameter to a transaction parameter associated with a pending transaction, and determining whether to process the pending transaction.

The fraud-prevention system includes an interface for selecting a user security parameter, a transaction unit for processing a transaction characterized by a transaction parameter, a security unit for comparing the user security parameter to the transaction parameter. The security unit instructs the transaction unit whether to process the transaction based on the comparison.

The fraud-prevention system in a further embodiment may also include means for setting a user security parameter by user instruction,means for comparing the user security parameter to a transaction parameter that characterizes a pending transaction, and means for determining whether to process the pending transaction based on the comparison. The fraud-prevent system, in a further embodiment, may also include a customer service support center.

The fraud-prevention system also includes a computer-readable storage medium containing a set of instructions for a general purpose computer having a user interface. The set of instructions includes a user security parameter selection routine operatively associated with the user interface for permitting a user to set a user security parameter associated with an applications program accessible to the computer. The set of instructions further includes a transaction routine for receiving a pending transaction, the pending transaction characterized by a transaction parameter. In addition, the set of instructions includes a parameter comparison routine responsive to the transaction routine for comparing the transaction parameter to the user security parameter, the transaction routine for determining whether to process the pending transaction based upon the comparison by said parameter comparison routine. The instructions can also occur in a third party system.

Other features, objects and advantages will be apparent from the description, the drawings and the claims.

### DESCRIPTION OF THE DRAWINGS

FIG. 1 depicts a system diagram.

FIG. 2 depicts a schematic diagram.

FIG. 3 depicts a system flow diagram.

FIG. 4 depicts a graphical user interface for setting a geographic location security parameter.

FIG. 5 depicts a graphical user interface for setting a monetary value range security parameter.

FIG. 6 depicts a graphical user interface for setting a transaction mode security parameter.

FIG. 7 depicts a graphical user interface for setting a class of services security parameter.

FIG. 8 depicts a graphical user interface for setting an account access security parameter.

FIG. 9 depicts a graphical user interface for setting a class of goods security parameter.

FIG. 10 depicts a graphical user interface for setting alert preferences.

FIG. 11 depicts an exemplary table having user security parameter data stored in a user security parameter database.

### DETAILED DESCRIPTION

A fraud-prevention system having user security parameters based on user instruction can include a network based security system that regulates transactions based upon a predetermined set of parameters specified by a user. A user is a customer, purchaser, cardholder, account manager, or agent having responsibility for the transaction. A user's identity can be verified by personalized parameters. A user specifies the security parameter for a transaction. The security parameter may include, but is not limited to a geographic location, a monetary value range, a transaction mode, an account access parameter, a class of goods, or a class of services. The user may vary these security parameters at any time. The user may specify certain security parameters for a predetermined amount of time only. For instance, the user may allow transactions from a particular geographic location for a period of time during which the user is on vacation at that location. The transaction may include, but is not limited to financial transactions and account access transactions.

The fraud-prevention system can acquire this security parameter information from the user and can store it in a user security parameter database. The user may specify these user security parameters at the outset of acquiring a financial account for conducting transactions, or at any time thereafter. The fraud-prevention system can use these user security parameters to screen subsequent transactions. When transactions contain indicia outside of the user security parameters, the fraud-prevention system may either warn the user with a warning message and allow the transaction, or the fraud-prevention system may block the transaction with our without sending a warning message. The fraud-prevention system allows transactions that comport with the user security parameters.

The fraud-prevention system screens fraudulent transactions by first establishing a user security parameter based on a user instruction. Then the system receives a transaction characterized by a transaction parameter. The system compares the transaction parameter to the user security parameter to evaluate the transaction. The system may further determine whether to process the transaction and provide notice to the user. A user may temporarily adjust the user security parameter for a predetermined period of time, such as for the duration of a business trip. It is desirable that the user security parameter be established prior to conducting any transactions. The fraud-prevention system manages financial transactions and account access transactions. The user security parameter can cover transaction characteristics such as, by means of a non-limiting example, geographic locations, monetary value ranges, transaction modes, account access parameters, classes of goods, and classes of services. The user may select a security parameter in which to allow transactions. The user may select a security parameter in which to block transactions. The user may further select a security parameter in which to send a notice to the user. In addition to utilizing the user security parameters, the fraud-prevention system my further analyze the transaction parameter with a neural network.

The fraud-prevention system also distinguishes fraudulent transactions from non-fraudulent transactions by providing an interface capable of setting a user security parameter by a user instruction, comparing a transaction parameter that characterizes a transaction to the user security parameter, and determining whether the transaction is fraudulent or non-fraudulent.

The fraud-prevention system further screens transactions by setting a user security parameter manually by a user instruction before processing any transactions, comparing the user security parameter to a transaction parameter associated with a pending transaction, and determining whether to process the pending transaction.

The fraud-prevention system includes an interface for selecting a user security parameter, a transaction unit for processing a transaction characterized by a transaction parameter, a security unit for comparing the user security parameter to the transaction parameter. The security unit instructs the transaction unit whether to process the transaction based on the comparison.

The fraud-prevention system in a further embodiment may also include means for setting a user security parameter by user instruction, means for comparing the user security parameter to a transaction parameter that characterizes a pending transaction, and means for determining whether to process the pending transaction based on the comparison.

The fraud-prevention system also includes a computer-readable storage medium containing a set of instructions for a general purpose computer having a user interface. The set of instructions includes a user security parameter selection routine operatively associated with the user interface for permitting a user to set a user security parameter associated with an applications program accessible to the computer. The set of instructions further includes a transaction routine for receiving a pending transaction, the pending transaction characterized by a transaction parameter. In addition, the set of instructions includes a parameter comparison routine responsive to the transaction routine for comparing the transaction parameter to the user security parameter, the transaction routine for determining whether to process the pending transaction based upon the comparison by said parameter comparison routine.

A fraud-prevention system having user security parameters based on user instruction can include a network based security system that regulates transactions based upon a predetermined set of parameters specified by a user. A user specifies the security parameter for a transaction. The security parameter may include, but is not limited to a geographic location, a monetary value range, a transaction mode, an account access parameter, a class of goods, or a class of services. The user may vary these security parameters at any time. The user may specify certain security parameters for a predetermined amount of time only. For instance, the user may allow transactions from a particular geographic location for a period of time during which the user is on vacation at that location. The transaction may include, but is not limited to financial transactions and account access transactions.

The fraud-prevention system can acquire this security parameter information from the user and can store it in a user security parameter database. The user may specify these user security parameters at the outset of acquiring a financial account for conducting transactions, or at any time thereafter. The fraud-prevention system can use these user security parameters to screen subsequent transactions. When transactions contain indicia outside of the user security parameters, the fraud-prevention system may either warn the user with a warning message and allow the transaction, or the fraud-prevention system may block the transaction with our without sending a warning message. The fraud-prevention system allows transactions that comport with the user security parameters.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer may include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link may include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software may be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

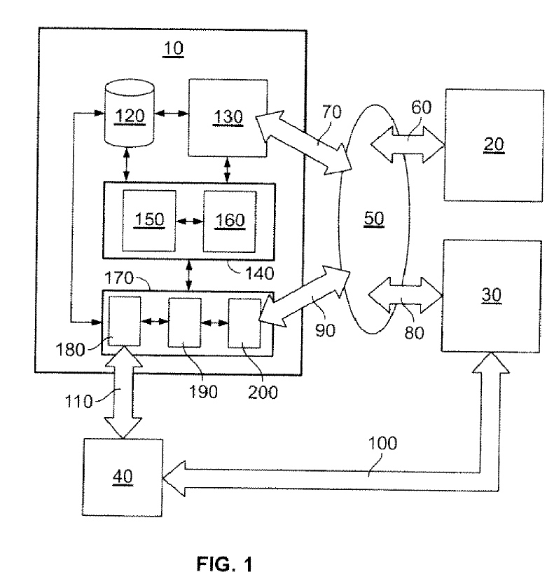

Referring to the Figures by characters of reference, FIG. 1 depicts a system diagram. Transaction system 10 processes electronic transactions, such as, for example, financial transactions or account access transactions. Transaction system is in communication with an entity 20, a user, and a customer service center 40 through a computer network 50. Entity, for example, may be business with a point of service terminal for conducting electronic transactions with a credit or debit card. Entity communicates with transactions system through a communications link 60 to computer network 50. A further communications link 70 connects computer network with transaction system. User communicates with transaction system through communications link 80 coupling user with computer network and communications link 90 coupling computer network with transaction system

User may communicate directly with customer service center 40 with communications link 100. Communications link may include, for example, telephone communications, written communications, and other forms of communication. Customer service center provides customer support for those who use transaction system. Customer service center communicates with transaction system through communications link 110.

Transaction system 10 includes a database 120, a transaction processing system 130, and a security center 140. Security center includes a user security parameter system 150 and a secondary security system 160. Transaction system further includes user security parameter management system 170. User security parameter management system includes a customer service center graphical user interface 180, user security parameter module 190, and a user graphical user interface 200.

Transaction processing system 130 receives transaction requests through communications link 70 from computer network 50. Such transaction requests may include purchases made by user with a credit card from business 20. Business would process the transaction by sending the credit card information through computer network to transaction processing system for approval. Prior to completing the processing of the transaction, transaction processing system will access security center. Security center is a system for examining pending transaction requests and sorting the legitimate transactions from fraudulent transactions. The transaction processing system can access the database directly and decline a transaction automatically based on rules.

The transaction request received by transaction processing system is described by several parameters. For instance, in a financial transaction, these parameters may include the geographical location of the transaction, the monetary value of the transaction, the mode of the transaction, the class of goods or services associated with the transaction. Alternatively, the transaction request received by transaction processing system could be an account access request from user, whereby user is attempting to access, by example, a financial account through computer network.

Transaction processing system would communicate these parameters describing the pending transaction request for analysis by security center. In the event that security center determines that the pending transaction request is legitimate, the security center will instruct the transaction processing system to allow and complete the transaction. Alternatively, should security center determine that the transaction is fraudulent, security center could instruct transaction processing system to deny and block the pending transaction request. Still further, in the event of a possible fraudulent transaction, security center may instruction transaction processing system to process the transaction, but transaction system would then also send a warning message to user warning them of the potentially fraudulent transaction.

Security center includes a user security parameter system and a secondary security system. User security parameter system is a security system that filters fraudulent transactions from legitimate transactions utilizing a set of user security parameters specified by a user. These user security parameters can include geographic parameters, monetary value range parameters, transaction mode parameters, account access parameters, class of goods or services parameters, and time duration parameters. For example, user may specify a set of user security parameters for his credit card to guard against others from making fraudulent purchases with his credit card. User may limit the geographic scope of his credit card to the United States. Still further, user could limit the geographic scope of his credit card to just the western United States, or even a particular state or city. In spite of the maximum credit limit allowed by the credit card, user may decide that they would never make a purchase over a certain amount of money less than the maximum credit limit allowed by the card. The user would then select their desired maximum spending limit as a further user security parameter, thereby restricting others from making purchases in excess of the specified user security parameter, but less than the maximum credit limit allowed by the credit card. User can limit the modes of transactions for his credit card by specifying a mode of transaction security parameter. For instance, user may decide that they would not make a purchase over the internet or would not use the credit card for an ATM withdrawal. User may further limit the use of his credit card by specifying user security parameters on the types of goods or services the user may buy with the credit card. For instance, user may set a parameter specifying that the user would never purchase cashier's checks or money orders using his credit card. User however, may determine that for a predetermined period of time, such as while on vacation, the user may wish to vary the user security parameters the user has set. Thus, user may allow certain geographic areas in his user security parameter settings where the user will be on vacation. User may also adjust the spending limits the user set on his card or vary the types of goods or services the user may wish to purchase with the card.

In the event that the transaction is an account request, user may specify account access user security parameters. For instance, user may only allow internet access to his account from his home or work computer. User may wish to block any telephone access to his account.

The use of user security parameters allows user to closely tailor the security parameters user by security center 140 to control and regulate transactions concern user's accounts. The use of user security parameters further limits the ability of unauthorized use of user's accounts.

User may also specify the action that security center is to take when a pending transaction request fails to comply with the user security parameters. User may specify that the security center is to block the transaction. User may specify that security center is to block the transaction and send a warning the user via email, text message, account message, or other mode of communication. User may also specify that security center allow the transaction, but send a warning message to user. User may tailor the user security parameters to include ranges where transactions are allowed, transactions are allowed but a warning is sent, and transactions are blocked. For instance, user may set the monetary value limit security parameter to allow all transactions under a certain monetary value. User may set the monetary value limit security parameter to allow transactions but send a warning message in a second higher monetary value range. The user may also block any transactions for a monetary value higher than the second monetary value range.

Security center 140 also includes a secondary security system 160. Secondary security system 160 may include a commercially available neural network, which can learn patterns of legitimate transactional behavior in order to filter out fraudulent transactions.

User accesses user graphical user interface 200 through computer network 50 in order to specify a set of user security parameters. User may also set these user security parameters, or seek help with setting the parameters with interface 200 by contacting customer support 40. User security parameter module 190 compiles the user security parameter information specified by user and communicates it to security center 140. Database 120 stores the user security parameter information.

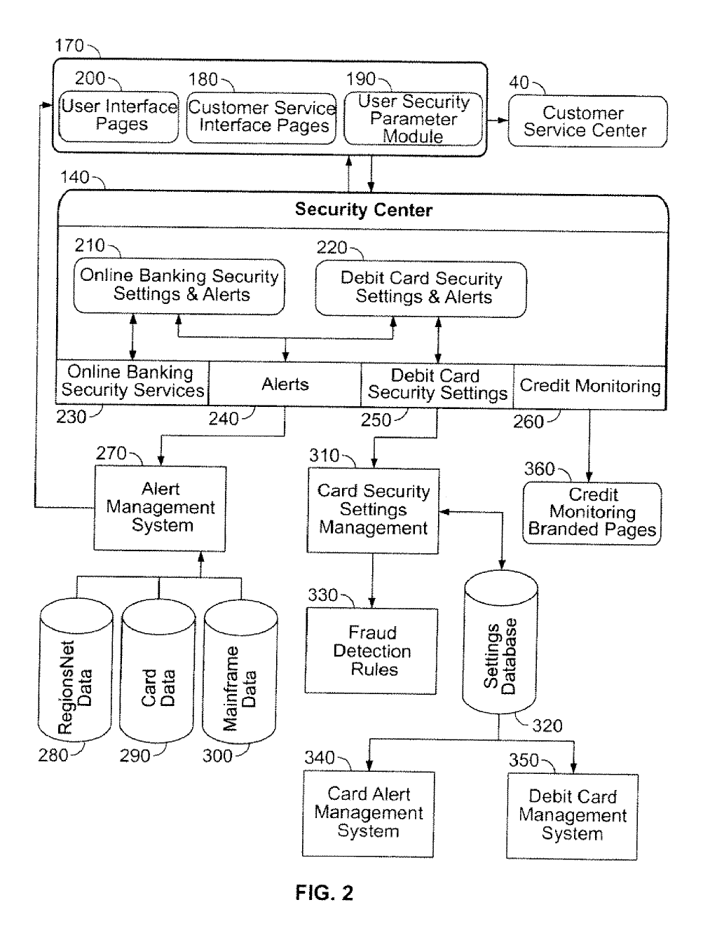

FIG. 2 is a schematic diagram. User security parameter management system 170 includes a customer service center graphical user interface 180, user security parameter module 190, and a user graphical user interface 200. User graphical user interface, includes a set of user interface pages viewable over a computer network, thereby allowing user to access user security parameter management system and specify his desired user security parameters. Customer service graphical user interface can communicate with customer service center 40 and can include a set of customer service interface pages.

Security center 140 includes a set of user security parameters for financial transactions, such as, by way of a non-limiting example, online banking security settings 210 and alerts and debit card security settings and alerts 220. Security center includes security modules, such as, by way of a non-limiting example, online banking security settings module 230, alert module 240, debit card security settings module 250, and credit monitoring module 260. Alert module 240 communicates with alert management system 270, which sends alerts to user when pending transaction requests have indicia that meet the user security parameters that require the transmission of a warning or alert to user.

Alert management system is in communication with databases 280, 290, and 300, which can be stored on database storage module. A database may include proprietary transaction system data. A database, for example, may include data regarding a credit card. A database can store mainframe data.

Debit card security settings module is in communication with card security settings management module 310 that manages the security settings of a card. Module stores data in settings database 320. Card security settings management module is in communication with an authentication system 330, such as neural network having fraud detection rules. Settings database is in communication with card alert management system 340 that sends warnings or alters to user when a pending transaction request has certain parameters that fail to meet the specified user security parameters. Settings database is also in communication with a debit card management system 350.

Credit monitoring module 260 is in communication with credit monitoring pages 360. Credit monitoring module, together with credit monitoring pages support security center with monitoring the credit of users.

FIG. 3 depicts a system flow diagram. User maintains his user security parameters in step 370. These user security parameters are uploaded to security center in block 380. Security system communicates with an authentication system, such as a neural network, which is operatively in communication with transaction processing system, in step 390, in order to provide real time updates of information to the authentication system. In step 400, user's user security parameters, which when user is a customer specify the level of his settings for conducting financial transactions, are loaded. In block 410, an authentication system makes a decision 420 as to whether pending transaction requests comply with the user security parameters, which are rules established by the customer user. In step 440, data is extracted from an authentication system. In step 450, qualifying information related to customer user levels, for example authentication system scores, are loaded into debit card management system in block 460. In step 470, qualifying information related to recorded disputes, such as authentication system scores, is loaded and transmitted to a dispute tracker module 480.

Customer alerts 430 in an alert management system is in communication with alert database 490, which communicates with security center in block 380 in order to send warning messages or alerts to user. Secondary security systems such as neural networks may be in communication with alert database 490, a third party alert 500, or an additional third party alert 510. A third party alert can be a report released by a third party notification system, which has a set of rules that monitor merchant activity patterns, card transaction and usage profiles. For example, on a specified time basis, a third party notification system can automatically synchronize data with payment card systems, collect authorization and transaction information, collect activity patterns for merchants, and usage patterns for cards and check it according to pre-defined rules. Each case of breaking of any rule is a subject to further tracking and analysis. The third party notification system can then perform suspicious case management and report about results of analysis by way of a third party alert. An alert can be a warning message, which can pop on a screen, or be sent to a user via e-mail or mobile phone. An alert can include a report on suspicious authorizations or transaction histories.

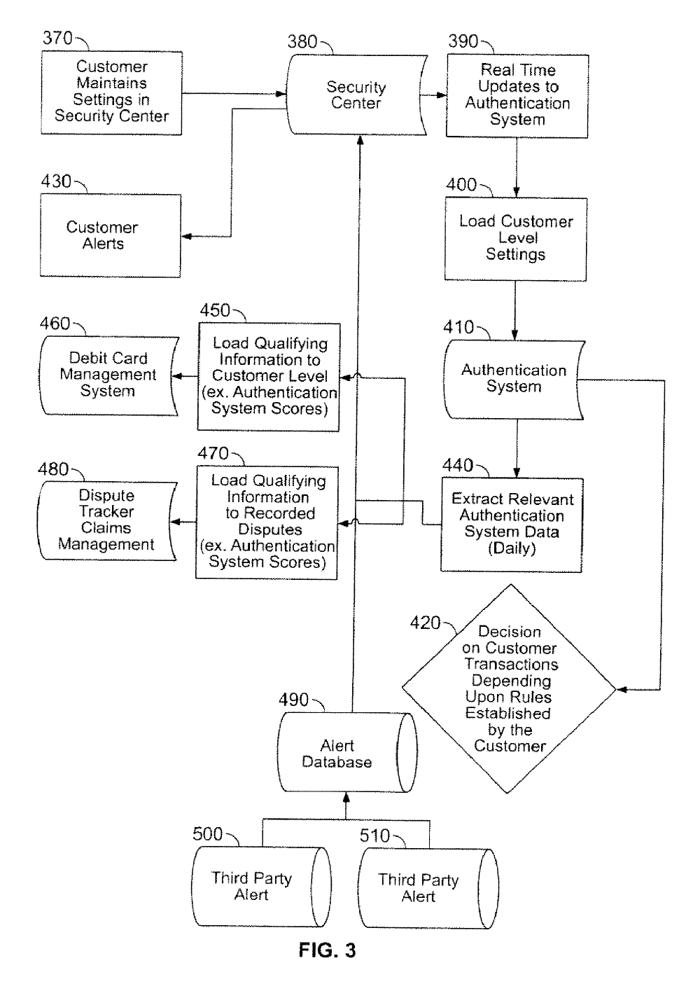

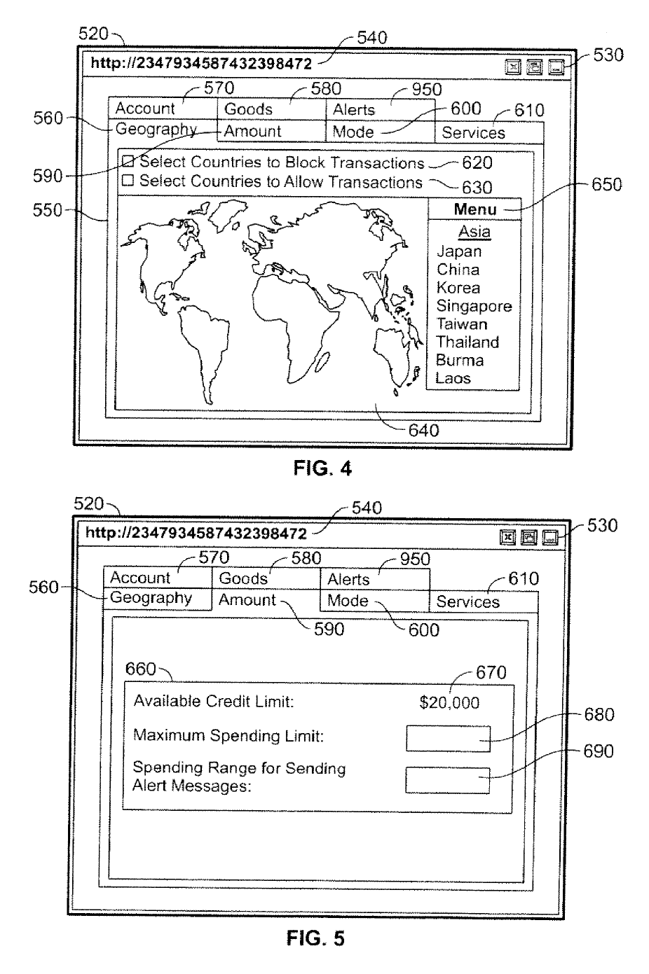

FIG. 4 depicts a graphical user interface for setting a geographic location security parameter. Graphical user interface 520 is depicted as a conventional Windows type environment screen display. Icons 530 to remove the screen, resize the screen, and minimize the screen are provided in the upper right portion of interface 520. User may access interface 520 by entering a URL 540 in an internet browser. Interface 520 includes user security parameter option program 550 that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 4, the geography user security parameter selection screen 560 has been chosen. User may select countries to block transactions by selecting option 620, or user may select countries to allow transactions by selecting option 630. An interactive map 640 is provided whereby a user can point and click on regions of the world to exercise options 620 and 630. Further, user may access menu 650, which in this non-limiting example displays countries in Asia user may select to employ options 620 or 630. Instead of countries, the geography menu can provide selections within countries by state or province, or by city, or other geographic boundary. Option 650 allows user to specify the mode of sending alerts.

FIG. 5 depicts a graphical user interface for setting a monetary value range security parameter. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 5, user has selected the amount 590 option to specify the user security parameter for the monetary value range of a credit card or debit card. Section 660 displays the maximum available credit limit 670 of the card. In section 680, user may specify the maximum spending limit they wish to set for the card. In section 690, user may specify a monetary value range in which they will allow transactions, but will receive a alert message for when they occur.

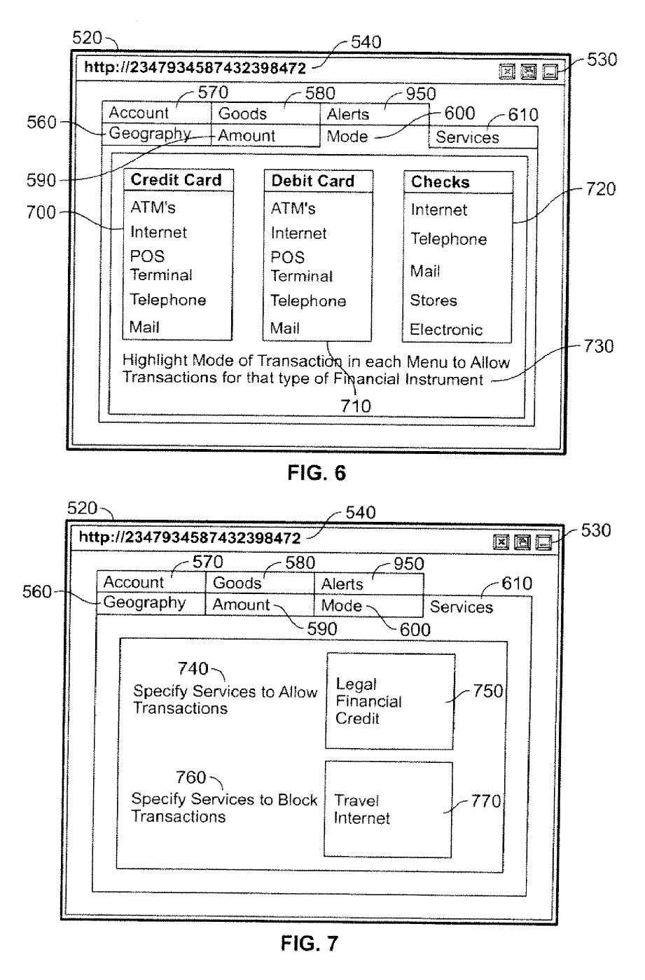

FIG. 6 depicts a graphical user interface for setting a transaction mode security parameter. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 6, user has selected to specify the user security parameter for the mode of transaction 600. In this non-limiting example, user may select a menu 700 for specifying the allowed modes of transactions for credit cards, a menu 710 for debit cards, and a menu 720 for checks. Each menu 700, 710, and 720 specifies various types of modes of transactions, such as ATM transactions, internet transactions, POS terminal transactions, telephone transactions, conventional mail transactions, and so on. In this example, as noted by message 730, user selects and highlights each of the modes of transactions in order to allow them. Unselected modes of transactions are consequently blocked from use. User may also select certain modes of transactions for which the user would receive alert messages.

FIG. 7 depicts a graphical user interface for setting a class of services security parameter. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 7, user has selected to set the user security parameter for a class of services in which they may allow transactions 740 with menu 750 or in which they may block transactions 760 with menu 770. Menus 750 and 770 list exemplary classes of services that user may select from. User may authenticate a system interface for setting an account access security parameter.

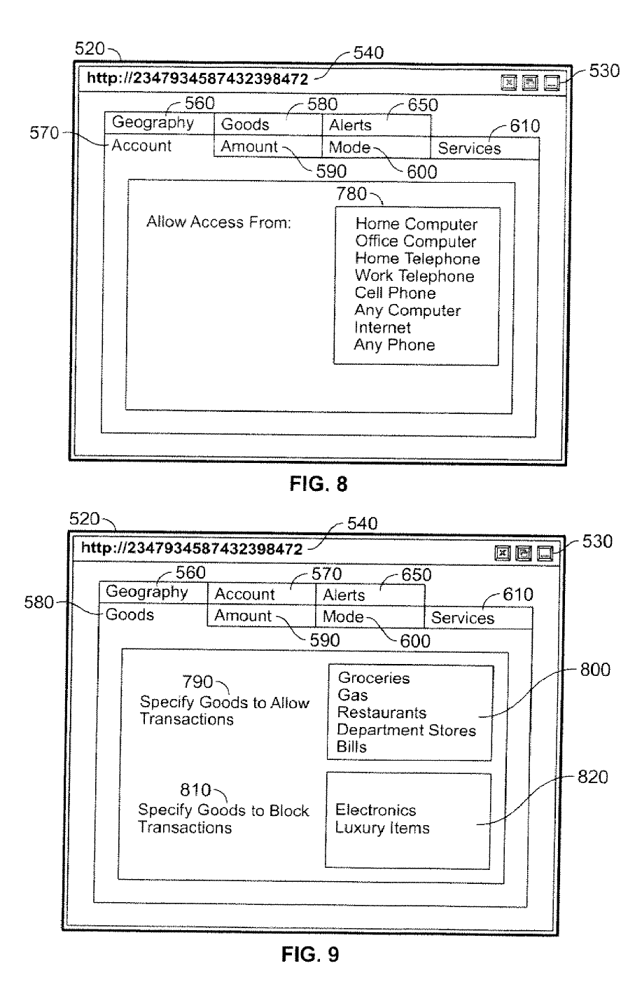

Referring to FIG. 8, user has selected the screen for setting a user security parameter for account access 570. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In option 570, user may specify with menu 780 various locations from which the user would allow access to his account. Menu 780 lists various locations from which user may attempt to access his account. Further, user may allow certain locations from which to access his account, but specify that the user receive warning message alerts if access is made from such location.

FIG. 9 depicts a graphical user interface for setting a class of goods security parameter. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 9, user has selected option 580 to specify a user security parameter for goods. User may select goods to allow transactions 790 for with menu 800, or user may specify goods in which to block transactions 810 with menu 820. User may use menus 800 and 820 to highlight classes of goods, such as groceries and electronics, in which to allow or block transactions. Further, user may specify classes of goods for which they will receive warning message alerts if purchases are made.

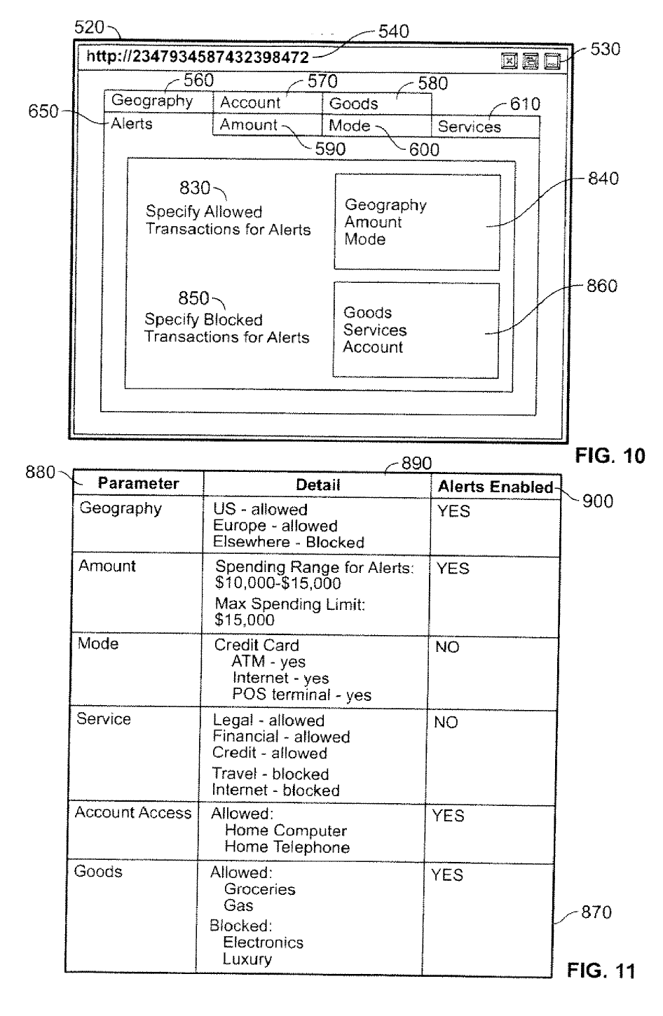

FIG. 10 depicts a graphical user interface for setting alert preferences. Graphical user interface 520 is depicted as a conventional Windows type environment screen display. Icons 530 to remove the screen, resize the screen, and minimize the screen are provided in the upper right portion of interface 520. User may access the interface by entering a URL 540 in an internet browser. Interface 520 includes user security parameter option program that allows user to specify their user security parameters. User, for example, may specify user security parameters for geography 560, account access parameters 570, type of goods that may be purchased 580, alert parameters 950, the amount of goods for purchase 590, the mode for transactions 600, and services available for purchase 610. In FIG. 10 a user has selected option 650 in which to specify user preferences for receiving message alerts. User may specify the user security parameters in which transactions are allowed 830 for which the user will receive message alerts. User may also specify the user security parameters in which transactions are blocked 850 for which the user will receive message alerts. User may also specify the mode in which the user will receive such alerts, such as through email, voice mail, text message, account message, or other modes of communication.

FIG. 11 depicts an exemplary table having user security parameter data stored in a user security parameter database. Database table 870 is compiled by module and transmitted to security center for use and database for storage. Table 870 includes a listing of user security parameters 880 and the preference details 890 chosen by user for each user security parameter. Table 870 includes a listing 900 for user's alert preferences as to whether they want alert warning messages sent for particular categories of user security parameters.

Although the systems and methods have been described in detail, it will be apparent to those of skill in the art that the systems and methods may be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method for screening fraudulent transactions, comprising:
establishing a user security parameter based on a user instruction;
receiving a transaction, the transaction characterized by a transaction parameter;
comparing the transaction parameter to the user security parameter to evaluate the transaction.

2. The method of claim 1, further comprising determining whether to process the transaction.

3. The method of claim 1, further comprising providing notice to the user.

4. The method of claim 1, further comprising temporarily adjusting the user security parameter for a predetermined period of time.

5. The method of claim 1, wherein the user security parameter is established prior to conducting any transactions.

6. The method of claim 1, wherein the transaction is a financial transaction or an account access transaction.

7. The method of claim 1, wherein the user security parameter is a geographic location, a monetary value range, a transaction mode, an account access parameter, a class of goods, or a class of services.

8. The method of claim 1, further comprising selecting a security parameter in which to allow transactions, to block transactions, or to send a notice to the user.

9. The method of claim 1, further comprising analyzing the transaction parameter with a neural network.

10. A method for distinguishing fraudulent transactions from non-fraudulent transactions comprising:
providing an interface capable of setting a user security parameter by a user instruction;
comparing a transaction parameter that characterizes a transaction to the user security parameter; and
determining whether the transaction is fraudulent or non-fraudulent.

11. The method of claim 10, wherein the user security parameter is a geographic location, a monetary value range, a transaction mode, an account access parameter, a class of goods, or a class of services.

12. The method of claim 10, further comprising sending a notice to the user.

13. The method of claim 10, further comprising temporarily adjusting said user security parameter for a predetermined period of time.

14. The method of claim 10, further comprising selecting a security parameter in which to allow transactions, to block transactions, or to send a notice to the user.

15. The method of claim 10, further comprising analyzing the transaction parameter with a neural network.

16. A method for screening transactions comprising:
setting a user security parameter manually by a user instruction before processing any transactions;
comparing the user security parameter to a transaction parameter associated with a pending transaction; and
determining whether to process the pending transaction.

17. The method of claim 16, further comprising analyzing the transaction parameter with a neural network.

18. The method of claim 16, wherein the user security parameter is a geographic location, a monetary value range, a transaction mode, an account access parameter, a class of goods, or a class of services.

19. The method of claim 16, further comprising sending a notice to the user.

20. The method of claim 16, further comprising temporarily adjusting the user security parameter for a predetermined period of time.

21. The method of claim 16, further comprising selecting a security parameter in which to allow transactions, to block transactions, or to send a notice to the user.

22. The method of claim 16, further comprising analyzing the transaction parameter with a neural network.

23. A transaction security system comprising:
an interface for selecting a user security parameter;
a transaction unit for processing a transaction, the transaction characterized by a transaction parameter;
a security unit for comparing the user security parameter to the transaction parameter, the security unit for instructing the transaction unit whether to process the transaction based on the comparison.

24. The system of claim 23, wherein the user security parameter is a geographic location, a monetary value range, a transaction mode, an account access parameter, a class of goods, or a class of services.

25. The system of claim 23, further comprising a user notification module for sending a user a message related to the transaction.

26. The system of claim 23, wherein the interface is a graphical user interface accessible through a computer network.

27. The system of claim 23, wherein the transaction is a financial transaction or an account access request.

28. The system of claim 23, wherein the security parameter is temporarily adjustable for preset periods of time.

39. The system of claim 23, further comprising a neural network for analyzing the transaction parameter.

30. A transaction security system, comprising:
means for setting a user security parameter by user instruction;
means for comparing the user security parameter to a transaction parameter, said transaction parameter for characterizing a pending transaction; and
means for determining whether to process the pending transaction based on the comparison.

31. The system of claim 30, wherein the user security parameter is a geographic location, a monetary value range, a transaction mode, an account access parameter, a class of goods, or a class of services.

32. The system of claim 30, further comprising a user notification module for sending a user a message related to the transaction.

33. The system of claim 30, wherein the interface is a graphical user interface accessible through a computer network.

34. The system of claim 30, wherein the transaction is a financial transaction or an account access request.

35. The system of claim 30, wherein the security parameter is temporarily adjustable for preset periods of time.

36. The system of claim 30, further comprising a neural network for analyzing the transaction parameter.

37. A computer-readable storage medium containing a set of instructions for a general purpose computer having a user interface, the set of instructions comprising:
a user security parameter selection routine operatively associated with the user interface for permitting a user to set a user security parameter associated with an applications program accessible to the computer;
a transaction routine for receiving a pending transaction, the pending transaction characterized by a transaction parameter; and
a parameter comparison routine responsive to the transaction routine for comparing the transaction parameter to the user security parameter, the transaction routine for determining whether to process the pending transaction based upon the comparison by said parameter comparison routine.

38. The computer-readable storage medium of claim 37, wherein the user security parameter is a geographic location, a monetary value range, a transaction mode, an account access parameter, a class of goods, or a class of services.

39. The computer-readable storage medium of claim 37, further comprising a user notification routine for sending a user a message related to the transaction.

40. The computer-readable storage medium of claim 37, wherein the transaction is a financial transaction or an account access request.

41. The computer-readable storage medium of claim 37, wherein the security parameter is temporarily adjustable for preset periods of time.

42. The computer-readable storage medium of claim 37, further comprising a neural network for analyzing the transaction parameter.
